(19) United States
(12) Patent Application Publication
(10) Pub. No.: US 2026/0017955 A1
(43) Pub. Date: Jan. 15, 2026

(54) METHOD AND SYSTEM FOR MONITORING PERFORMANCE AND STATE OF ACTIVE ROAD STUDS INSTALLED IN ROADWAY

(71) Applicant: CLEARVIEW INTELLIGENCE LTD., Milton Keynes, Buckinghamshire (GB)

(72) Inventor: Alastair KING, Northampton, Northamptonshire (GB)

(73) Assignee: CLEARVIEW INTELLIGENCE LTD., Milton Keynes, Buckinghamshire (GB)

(21) Appl. No.: 18/994,341

(22) PCT Filed: Jul. 28, 2022
(86) PCT No.: PCT/IB2022/057021

§ 371 Date: Jan. 14, 2025

(51) Int. Cl. G06V 20/56; G06T 7/00

(52) U.S. Cl. CPC G06V 20/588; G06T 7/0002; G06T 2207/10016; G06T 2207/30256

(57) ABSTRACT

A method and system for monitoring active road studs installed in a roadway utilizes a vehicle having a detection device. The detection device includes a video camera for recording a video of the installed active road studs as the vehicle is driven along the roadway. The detection device further includes a processor configured to analyze the recorded video to detect a level of light emitted by the installed active road studs and to determine therefrom a brightness level and a state of the installed active road studs.

### TECHNICAL FIELD

The present invention generally relates to monitoring road studs installed in a roadway and, more particularly, to active road stud monitoring.

### BACKGROUND

Road studs (e.g., pavement markers) are installed in roads to mark lanes and edges of the roads. Certain type of road studs, such as reflective road studs (or retroreflective road studs), reflect light such as from vehicle headlights in order to be visible to vehicle drivers. Other types of road studs, such as active road studs, emit light in order to be visible to vehicle drivers. Vehicle drivers are to be able to visually observe installed road studs while driving on a road in order to properly follow the road including any curves and corners of the road.

It is desirable for an operator of the road and/or of the installed road studs to be able to determine performance levels and state (i.e., on/off) of the installed road studs. Determined performance levels and state of the installed road studs can be compared with standards to ensure compliance with regulations. Most importantly, determined performance levels and state of the installed road studs can be analyzed to confirm that the vehicle drivers will be able to see their route on the road ahead in the hours of darkness.

Conventional technology provides a method of determining the levels of retro reflectivity of reflective road studs installed in a road. This conventional technology involves the use of a ‘reflectometer’ device configured to detect reflected light from reflective road studs. In use, the reflectometer is attached to a vehicle and the vehicle is driven down the road. As the vehicle is driven down the road, the reflectometer monitors the level of light reflected back from installed reflective road studs to the reflectometer. The obtained reflective light data may then be collated, and a report can be generated to highlight the current level of performance of the reflective road studs.

As noted, active road studs, such as those road studs compliant with the standard BS EN 1463.3, emit visible light for vehicle drivers to see as opposed to reflecting light back to the vehicle drivers. Accordingly, the performance levels and state of installed active road studs cannot be determined with the reflectometer. Understandably, without determined performance levels and state of installed active road studs, it is difficult for an operator to understand performance of the active road studs (and design thereof) over time and makes difficult road installation validation, road operator handover, and opportunities to supply active road studs.

### SUMMARY

Embodiments of the present invention provide a method and system of monitoring active studs in a road, airport or runway environment (collectively “road studs”) installed in a roadway, runway, taxiway, or a like surface (collectively “roadway” or “road”) to determine the level of performance and state of the active road studs.

In embodiments, the method and system involve the use of a detection device having a video camera, a controller, and a processor. The detection device is preferably implemented in a ‘kit’ form. The detection device is to be added to a vehicle that is to be driven along a road having a plurality of installed active road studs. The video camera may be fitted either in front of the vehicle nearer ground level on a mounting bracket or within the vehicle looking outward through the vehicle windshield. In use, as the vehicle is driven down the road, the video camera records the installed active road studs, particularly, the light emitted from the installed active road studs. The recorded video is analyzed either on-board by the processor and/or off-board such as by an online data collection platform to detect the level of light emitted from the installed active road studs. The obtained recorded light data may then be collated by the processor and/or the online data collection platform, and a report can be generated by the processor and/or the data collection platform to highlight the current level of performance of the installed active road studs.

The components of the detection device are selected to have sufficient recording and processing capabilities such that the monitoring of the installed active road studs by the detection device is accurate at least up to a vehicle speed of 70 mph.

In some embodiments, the controller is configured to provide an interactivity with the vehicle driver so that the vehicle driver can determine ‘start’ and ‘end’ period of analysis of the installed active road studs. That is, the ‘start’ and ‘end’ period of analysis represents when the monitoring of the installed active road studs to detect the performance levels and the state (i.e., on/off) of the installed active road studs will start and finish. By using video analytics, a full recording can be played back should there be any queries on the scan results.

The detection device including the video camera has direct communication with the online data collection platform to submit results of any recorded video scan after the recorded video scan has been marked as ‘finished’ by the vehicle driver.

In some embodiments, the video camera and/or the processor of the detection device have functionality to analyze video of the active road studs recorded by the video camera to detect the state (i.e., on/off) of each of the active road studs and the brightness level of each of the active road studs. Depending on the wide-angle lens capabilities of the video camera, the detection device is operable to monitor the active road studs installed in one lane (i.e., the active road studs installed in the left and right sides of the lane) or the active road studs installed in two or more lanes. This functionality may be user configurable so that data can be collected from either left, right, or both left and right lanes.

In some embodiments, the detective device is configured to transmit the detected data of the state and brightness levels of the installed active road studs to a central data collection platform such as the online data collection platform with a generalized report of the detected data. For instance, the generalized report may include information indicative of the percentage of the installed active road studs that are in an off state and an accumulative level of brightness of the installed active road studs.

In some embodiments, the detection device further includes a global navigation satellite system (GNSS) (e.g., a global positioning system (GPS)) and/or is operable with a GNSS of the vehicle to associate GNSS coordinates with the installed active road studs recorded by the video camera. In operation, the processor combines the video recorded by the video camera with the GNSS information at the time of the recording to thereby log GNSS location information with the recorded installed active road studs. As such, the detection device can submit exact GNSS coordinates of active road studs that have been deemed to be in an ‘off’ state and show on a report within the central data collection platform.

In some embodiments, the detection device further includes a timer and/or is operable with a timer of the vehicle to associate time information with the installed active road studs recorded by the video camera. The time information may include time of day (TOD) for context of the part of the day that the installed active road studs were recorded, e.g., morning, midday, evening, night. The time information may include date information in the context of the season of the year, e.g., spring, summer, autumn, and fall. The date information may also be used for historical comparison purposes.

As the recorded data may be logged by GNSS coordinates in conjunction with time information, the central data collection platform will be able to hold historic information when a prior test has been completed and raise historic information for comparison against more recent tests. This would give the method and system the benefits of monitoring the brightness level of the installed active road studs collectively and/or individually to detect any ultimate degradation over time, providing indication that the installed active road studs collectively and/or individually are reaching their end of life and may need to be replaced, and providing validation that reinstallation of new active road studs in place of old active road studs has had a desired outcome.

### BRIEF DESCRIPTION OF THE DRAWINGS

FIG. 1 illustrates a block diagram of a detection device for monitoring active road studs installed in a roadway to determine the level of performance and state of the active road studs.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

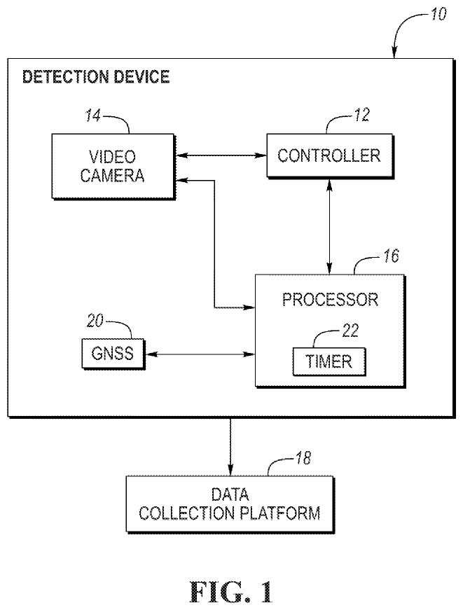

Referring now to FIG. 1, a block diagram of a detection device 10 for monitoring active road studs installed in a roadway to determine the level of performance and state of the installed active road studs is shown. As noted, when functional, the active road studs emit light that is visible for vehicle drivers to see. Detection device 10 includes a controller 12, a video camera 14, and a processor 16. Detection device 10 is to be added to a vehicle or a drone (collectively “vehicle”) (not shown) that is to be driven along the roadway. Video camera 14 records the installed active road studs as the vehicle is driven along the roadway. Video camera 14 and/or processor 16 may analyze the recorded video to detect the level of light emitted from the installed active road studs and provide reporting information concerning same. As such, detection device 10 is configured to detect the brightness performance levels and state (i.e., on/off) of the installed active road studs.

Detection device 10 may be in communication with an online data collection platform 18 to provide the obtained recorded light data to the online data collection platform for more detailed analysis/reporting and/or archiving.

Controller 12 is configured to provide an interactivity with the vehicle driver so that the vehicle driver can determine ‘start’ and ‘end’ period of analysis of the installed active road studs.

Detection device 10 may further include a global navigation satellite system (GNSS) (e.g., a global positioning system (GPS)) 20 and/or be operable with a GNSS of the vehicle to associate GNSS coordinates with the installed active road studs recorded by the video camera. Video camera 14 and/or processor 16 combines the video recorded by the video camera with the GNSS information at the time of the recording to thereby log GNSS location information with the recorded installed active road studs.

Detection device 10 (e.g., video camera 14 and/or processor 16) preferably further includes a timer 22 to associate time/day/date information with the installed active road studs recorded by the video camera.

As described, detection device 10 satisfies the need for being able to determine and monitor the performance of active road studs after the active road studs have been installed in a roadway.

Detection device 10 may use various algorithms, by itself and/or in conjunction with online data collection platform 18, in detecting brightness levels and state of the installed active road studs. The algorithms may be enhanced to further ensure accuracy of detection device 10.

Features of detection device 10 include functionality for vehicle driver to ‘start’ and ‘stop’ scan, edge video camera device to automatically upload data (including video stream) to a cloud-based platform, route mapping with GNSS coordinates against installed active road studs outside of specification, and cloud/user alerting for installed active road studs outside of specification.

The use of detection device 10 will enable a better understanding of early lifetime failure of active road studs as a percentage. Detection device 10 may be used as a diagnosing tool and/or a sales tool to help deploy better delineation on the road network.

Detection device 10 may further be operable to present other information alongside the active road stud state and brightness levels. This may involve battery level information (each active road stud has a battery and a lighting device such as a light-emitting diode (LED), the battery powering the LED to emit the visible light), active road stud tagging (to register the active road stud age against a manufacturing database), and the ability for active road studs to issue a historical report when the scanning device is present (submission of lifetime battery capacity, etc.).

In some embodiments, video camera 14 of detection device 10 may be one or more video cameras. Video camera(s) 14 may be mounted in different ways. Further, an alternative cloud-based platform may be generated with use of detection device 10.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A detection device for monitoring active road studs installed in a roadway, the detection device comprising:
a video camera for recording a video of the installed active road studs as a vehicle having the detection device is driven along the roadway; and
a processor configured to analyze the recorded video to detect a level of light emitted by the installed active road studs and to determine therefrom a brightness level and a state of the installed active road studs.

2. The detection device of claim 1 wherein:
the processor is operable to provide the determined brightness level and state of the installed active road studs to an online data collection platform for the online data collection platform to generate a report concerning same.

3. The detection device of claim 1 further comprising:
a controller configured to provide an interactivity with a driver of the vehicle so that the driver can determine a start and an end period of analysis of the installed active road studs.

4. The detection device of claim 1 wherein:
the video camera is operable to record a video of active road studs installed on both sides of one lane of the roadway as the vehicle having the detection device is driven along the one lane of the roadway.

5. The detection device of claim 1 wherein:
the video camera is operable to record a video of active road studs installed on multiple lanes of the roadway as the vehicle having the detection device is driven along one of the multiple lanes of the roadway.

6. The detection device of claim 1 wherein:
the processor is further configured to combine the recorded video with global navigation satellite system (GNSS) information at the time the recorded video was recorded by the video camera to thereby log GNSS information with the installed active road studs.

7. The detection device of claim 1 wherein:
the processor is further configured to combine the recorded video with time information indicative of the time at which the recorded video was recorded by the video camera to thereby log time information with the installed active road studs.

8. A method for monitoring active road studs installed in a roadway, the method comprising:
recording, by a video camera installed on a vehicle, a video of the installed active road studs as the vehicle is driven along the roadway; and
analyzing, by a processor, the recorded video to detect a level of light emitted by the installed active road studs and to determine therefrom a brightness level and a state of the installed active road studs.

9. The method of claim 8 further comprising:
combining, by the processor, the recorded video with global navigation satellite system (GNSS) information at the time the recorded video was recorded by the video camera to thereby log GNSS information with the installed active road studs.

10. The method of claim 8 further comprising:
combining, by the processor, the recorded video with time information indicative of the time at which the recorded video was recorded by the video camera to thereby log time information with the installed active road studs.

11. A detection device for monitoring active studs installed in an airport environment, the detection device comprising:
a video camera for recording a video of the installed active studs as a vehicle having the detection device is driven in the runway environment: and
a processor configured to analyze the recorded video to detect a level of light emitted by the installed active studs and to determine therefrom a brightness level and a state of the installed active studs.
